(19) United States
(12) Patent Application Publication
(10) Pub. No.: US 2005/0159991 A1
(43) Pub. Date: Jul. 21, 2005

(54) Job control system and method for controlling job processing

(76) Inventors: Anna Hashuber, Munchen (DE); Bernd Milzarek, Heroldsbach (DE); Elvira Renner, Landshut (DE)

Correspondence Address: YOUNG & THOMPSON, 745 SOUTH 23RD STREET, 2ND FLOOR, ARLINGTON, VA, 22202, US

(21) Appl. No.: 10/963,534

(22) Filed: Oct. 14, 2004

(30) Foreign Application Priority Data
Oct. 10, 2003 (EP) 03023551.9

(51) Int. Cl. G06F 17/60

(52) U.S. Cl. 705/9; 700/100

(57) ABSTRACT

To control job processing, in response to a job processing request from a first unit based on control parameters for job processing by at least a second unit, job information is created for a job to be processed by the second unit. The job information is stored in a job memory for retrieval by the second unit. The job information includes at least a job descriptor, an event and status indicator, a predefined completion time and details about the resources assigned for the job to be processed. Changes to the event and/or status indicator are continually logged.

A networked job control system enables jobs to be issued automatically and manually between locations within a corporate unit, department or group. In addition to reducing the flow of paper, a networked job control system offers further advantages. For example, the length of time taken to transfer a job is minimized.

The object of the present invention is to provide an efficient method for controlling job processing and an appropriate job control system to implement the method.

According to the present invention, this object is achieved by a method in accordance with the features indicated in claim 1 and by a job control system with the features indicated in claim 8. Beneficial features of the present invention are given in the dependent claims.

According to the present invention, in response to a job-processing request from a first unit based on control parameters for job processing by at least a second unit, job information is created for a job to be processed by the second unit. The job information is then stored in a job memory for retrieval by the second unit. The job information includes at least a job descriptor, an event and status indicator, a predefined completion time and details about the resources assigned for the job to be processed. Changes to the event and/or status indicator are continually logged. This results in particularly efficient job-processing control which in particular enables a comparatively lower demand on resources in communication networks and data processing systems.

The details about the resources assigned for the job to be processed can for example indicate an operator or file location.

Preferably, the job information stored in a job memory is also available for retrieval by the first unit. The job information stored in a job memory can then be arranged according to organizational units or locations assigned to the first and/or second unit.

In a preferred embodiment of the present invention, the control parameters are stored in a parameter file for cooperation agreements.

Preferably, the logged changes to the event and/or status indicator for the first and/or second unit can be retrieved. The logged changes to the event and/or status indicator are preferably provided in the job memory.

A job control system according to the present invention includes a device for generating job information, in response to a job-processing request from a first unit based on control parameters for job processing by a second unit, to be processed by the second unit. Furthermore, a device to make the job information available for retrieval in a job memory for the second unit is planned. The job information includes at least a job descriptor, an event and status indicator, a predefined completion time and details about the resources assigned for the job to be processed. Furthermore, a job control system according to the present invention will have a unit that continually logs the changes to the event and/or status indicator.

The present invention will now be described in more detail with reference to the accompanying drawings. The drawings:

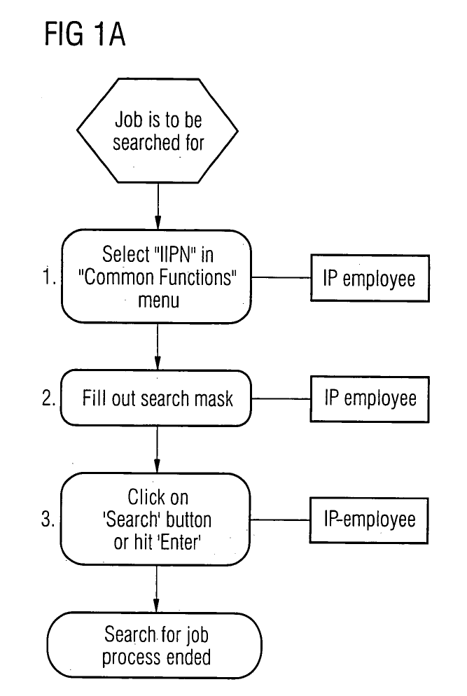

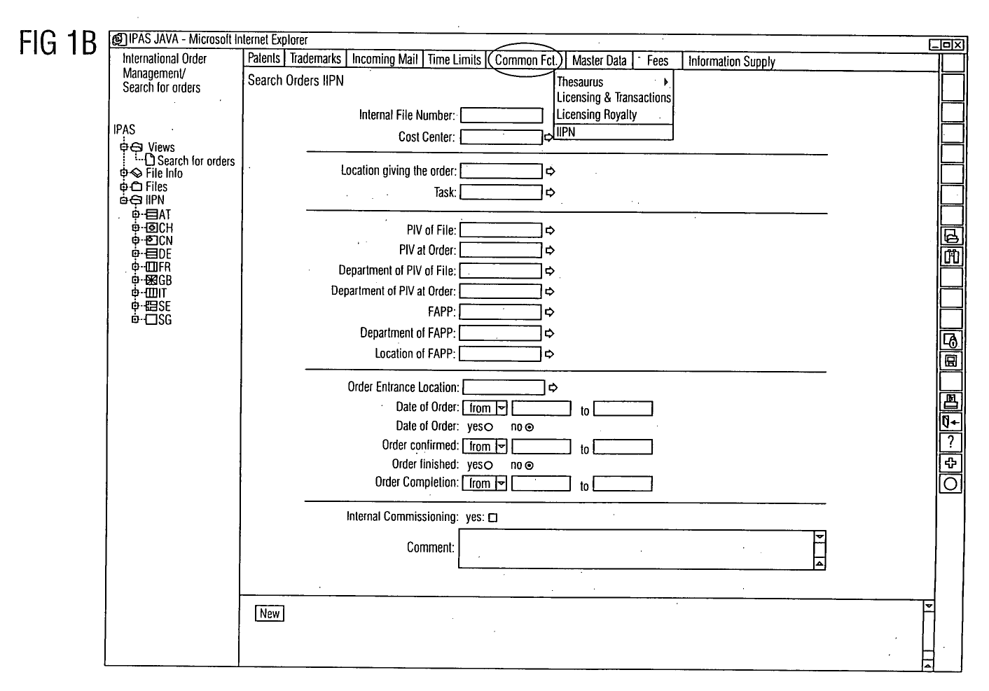

FIG. 1a a flow diagram to search for a job

FIG. 1b a job search mask in a suitable job control system to implement a method for controlling job processing,

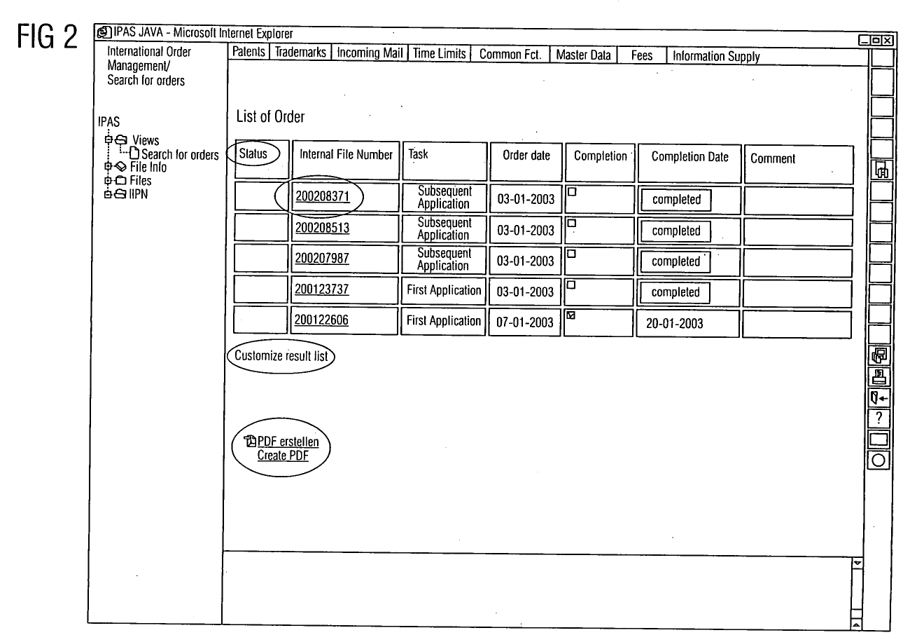

FIG. 2 a screen mask of a job control system with a job list,

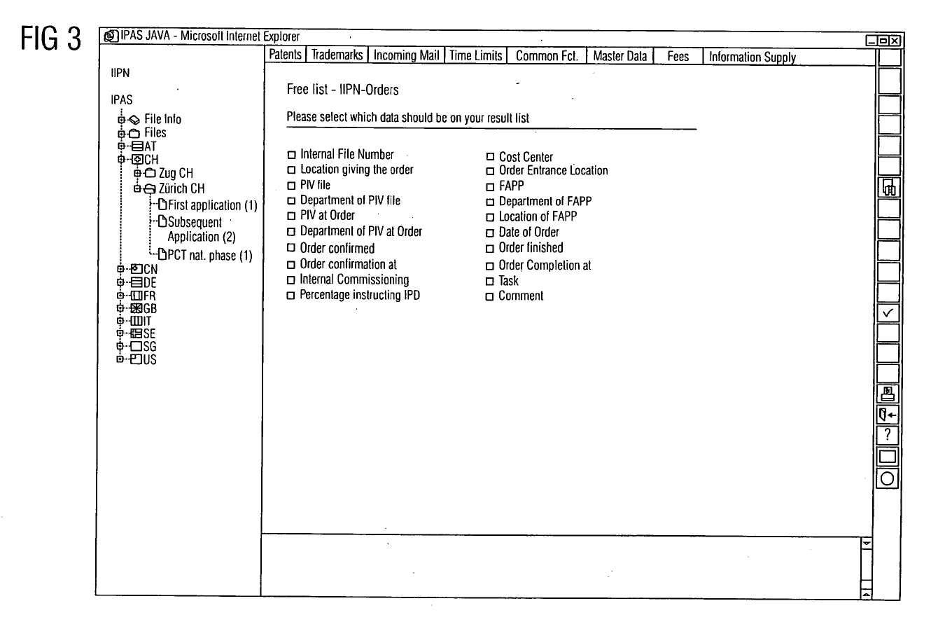

FIG. 3 a screen mask with an empty event list,

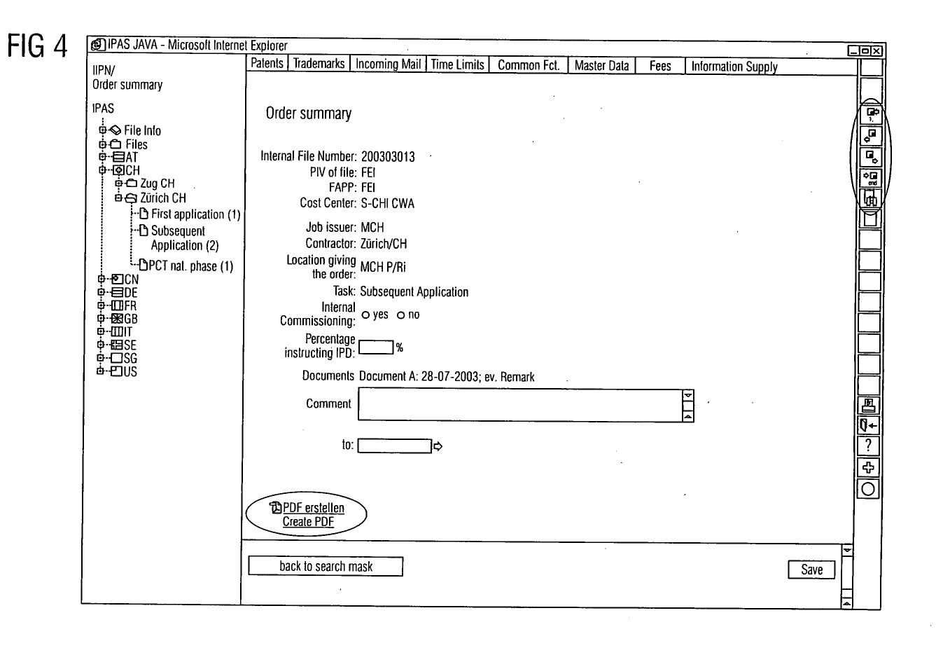

FIG. 4 a screen mask with a job view,

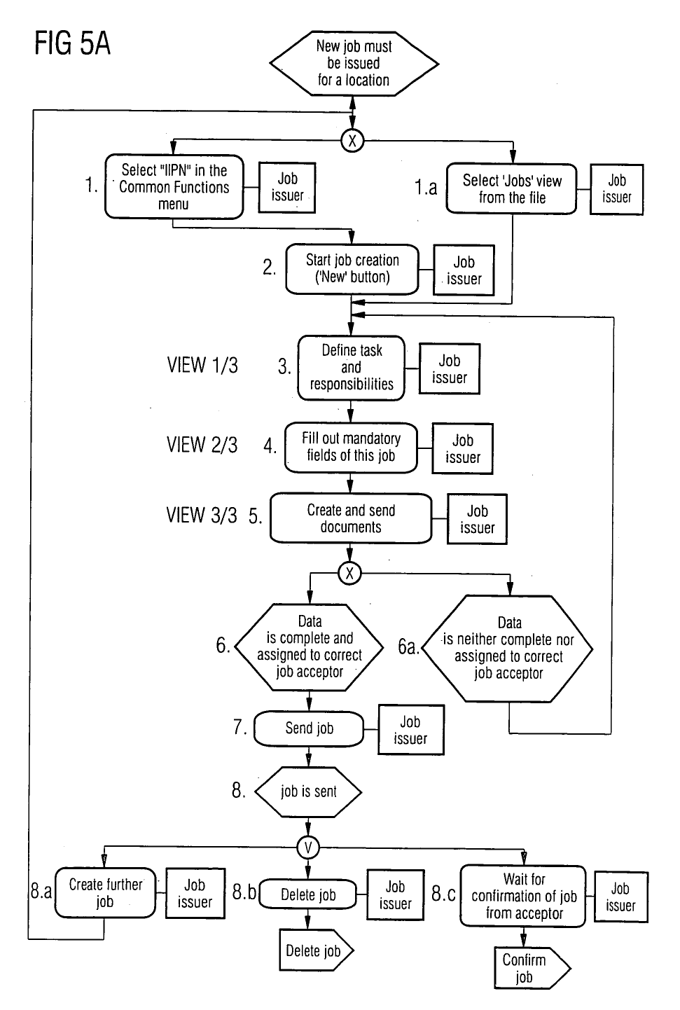

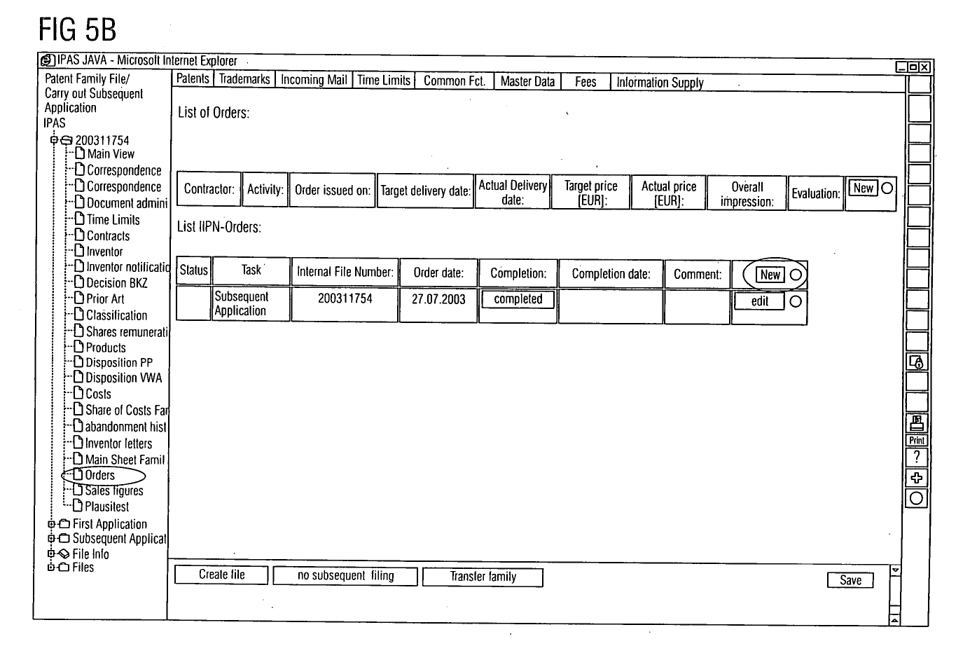

FIG. 5a a flow diagram to create a job

FIG. 5b a screen mask to create a job via a job view,

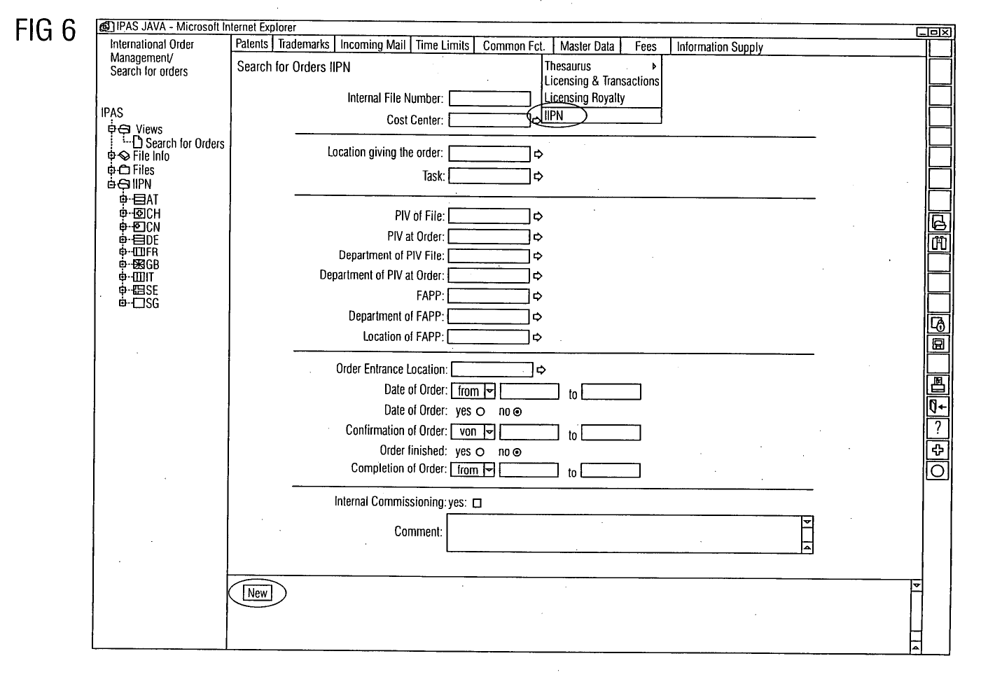

FIG. 6 a screen mask to create a new job via the job control system,

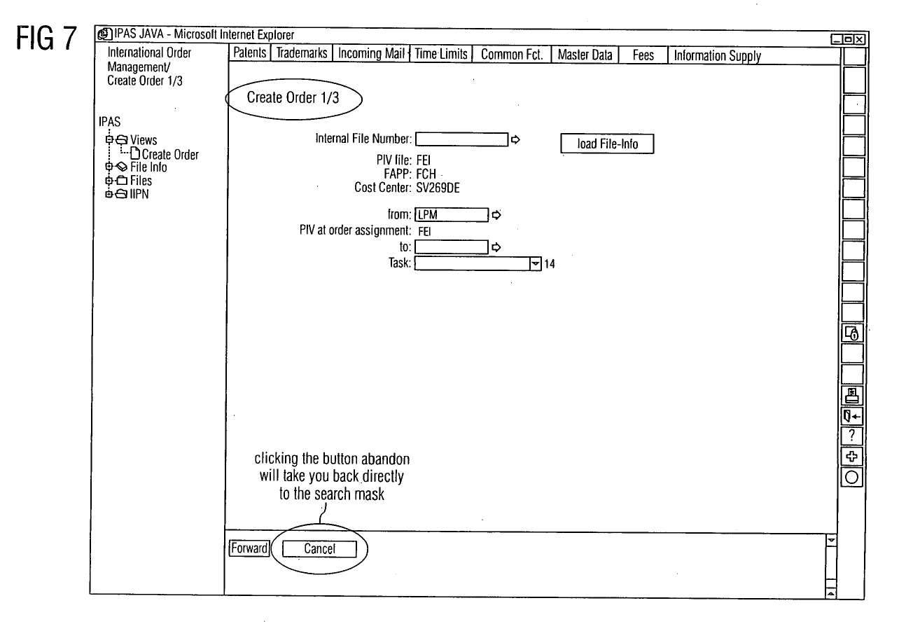

FIG. 7 a first of three views of a screen mask for creating a job,

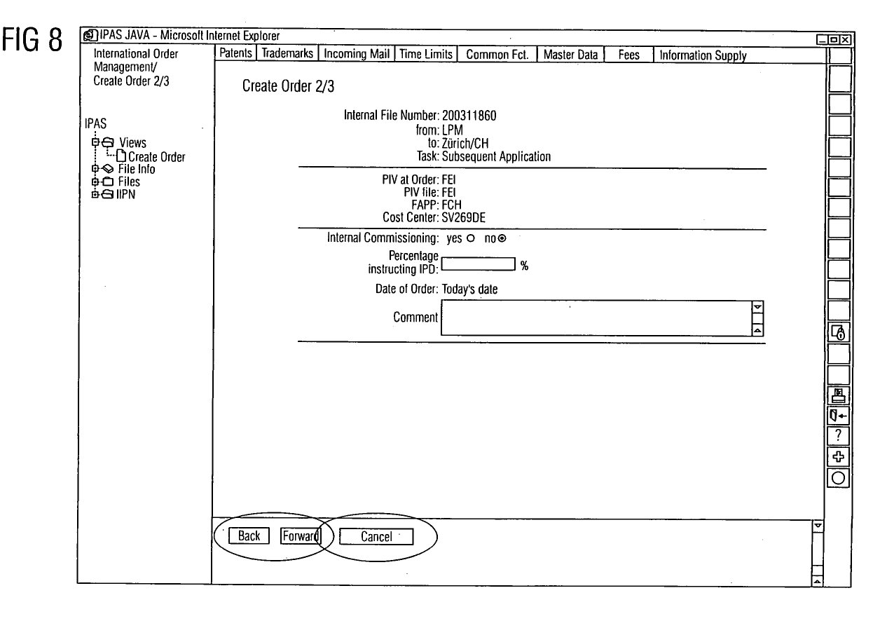

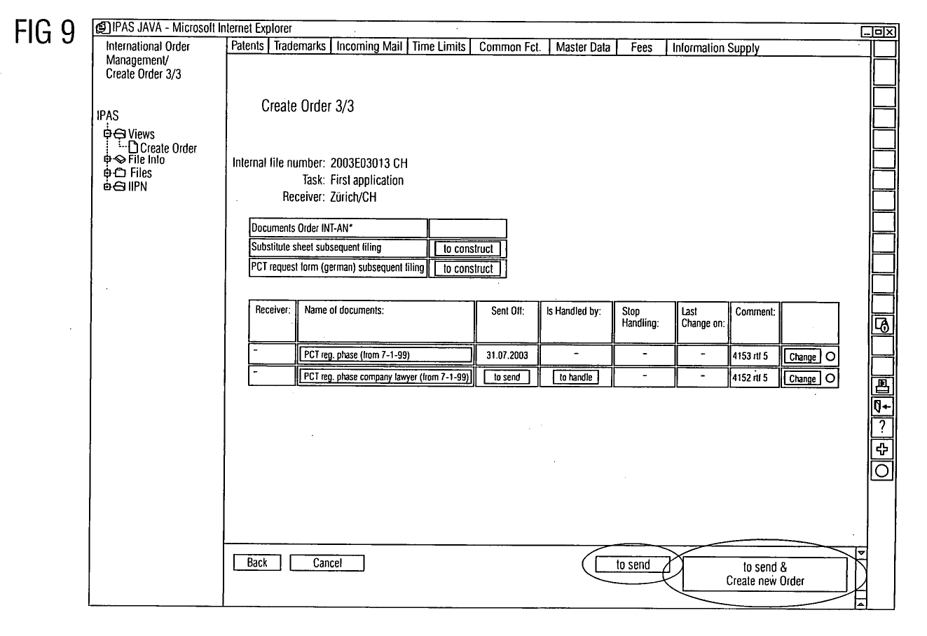

FIG. 8 a second view of a screen mask for creating a job,

FIG. 9 a third view of a screen mask for creating a job,

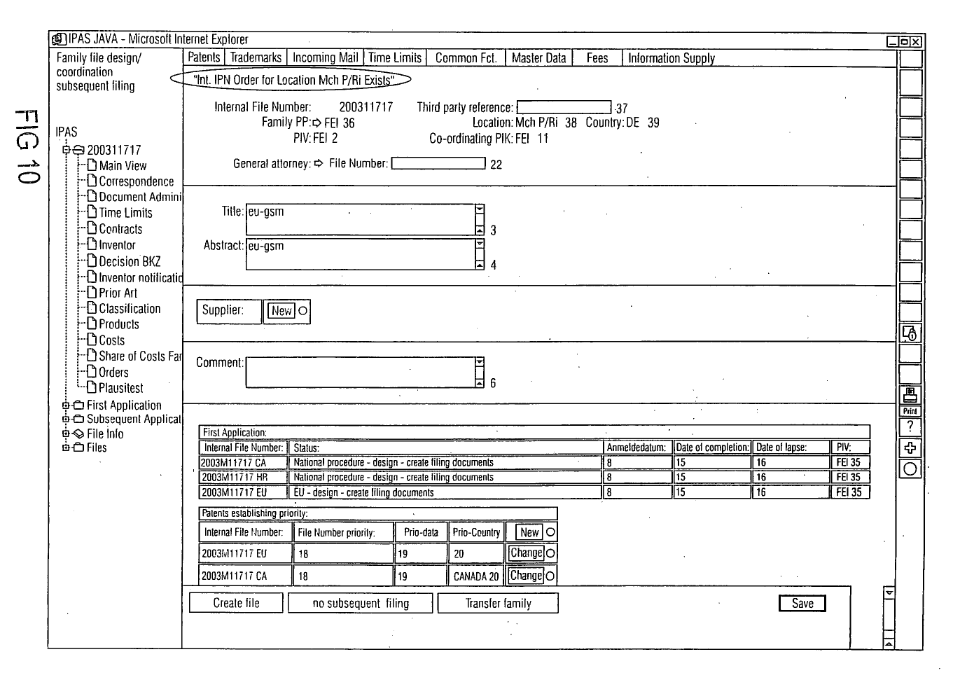

FIG. 10 a screen mask with a message on this processing job,

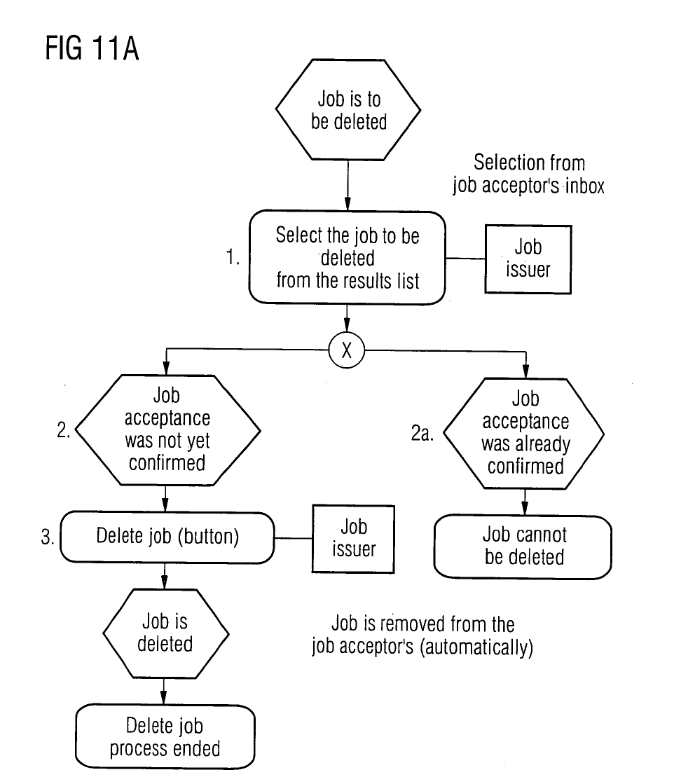

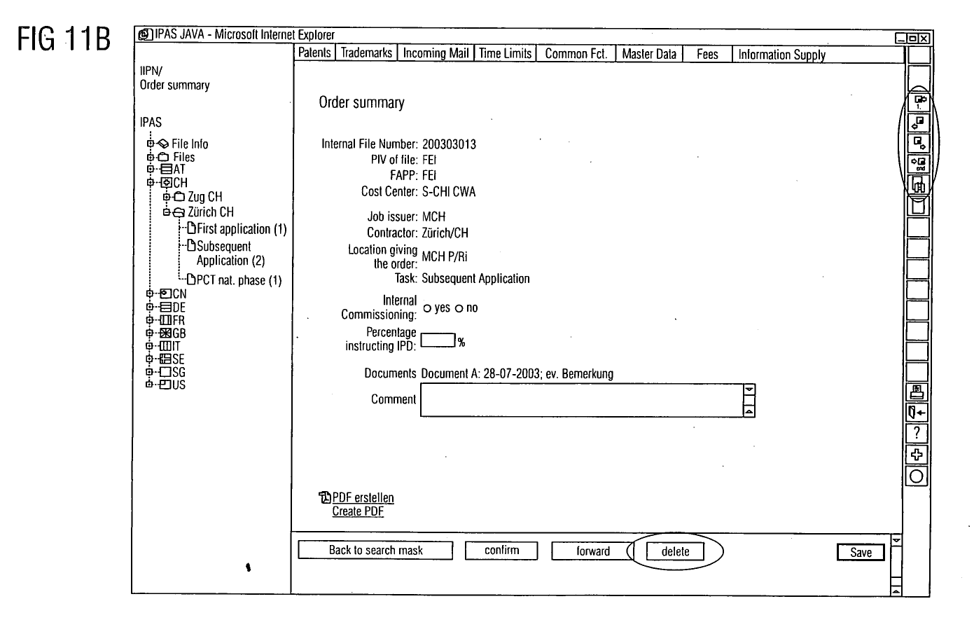

FIG. 11a a flow diagram to delete a job

FIG. 11b a screen mask to delete a job

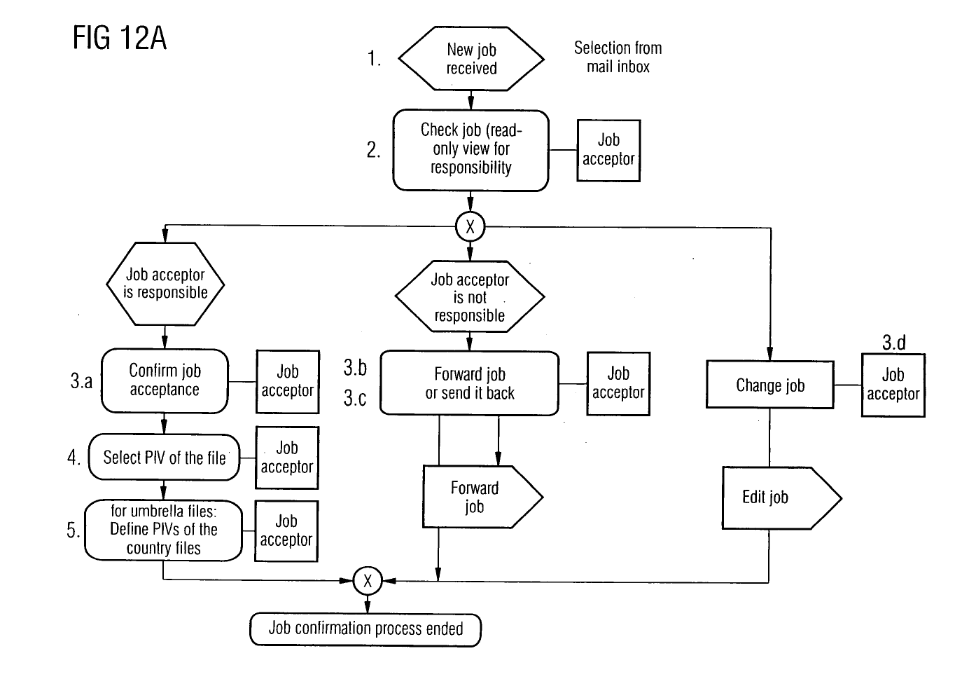

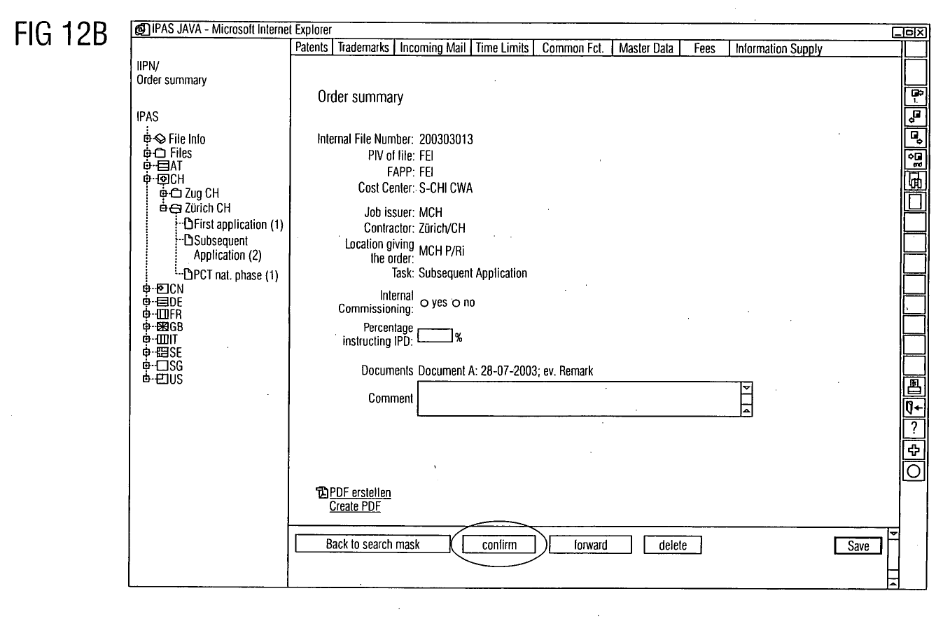

FIG. 12a a flow diagram to confirm a job

FIG. 12b a screen mask to confirm a job

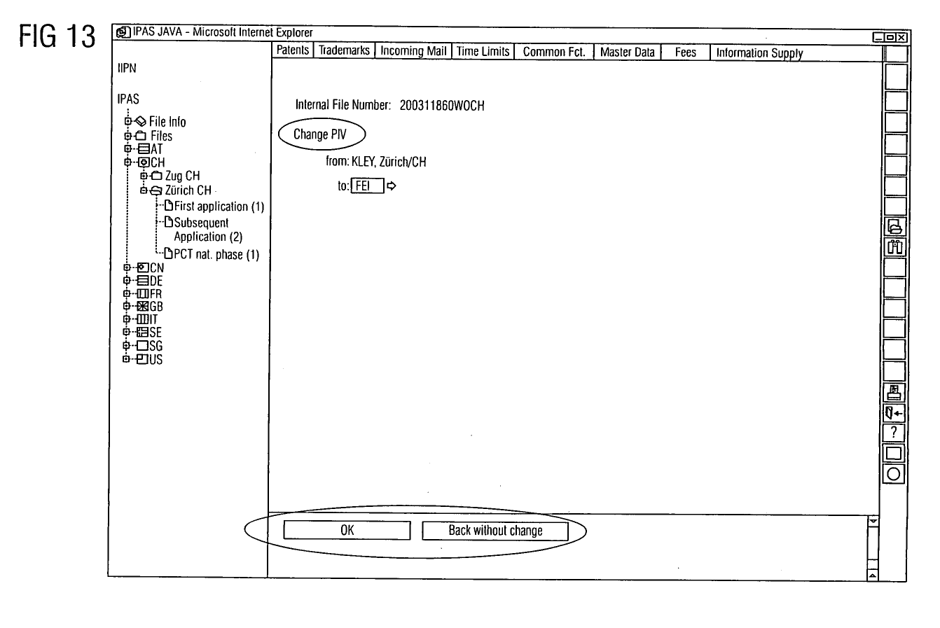

FIG. 13 a screen mask to change the user of a file,

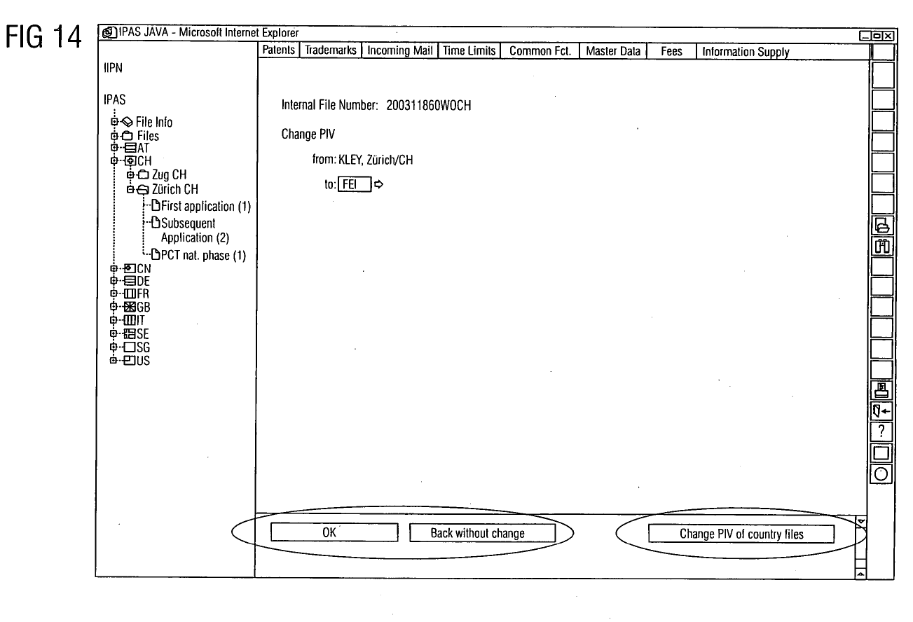

FIG. 14 a screen mask to change the user of a superior file,

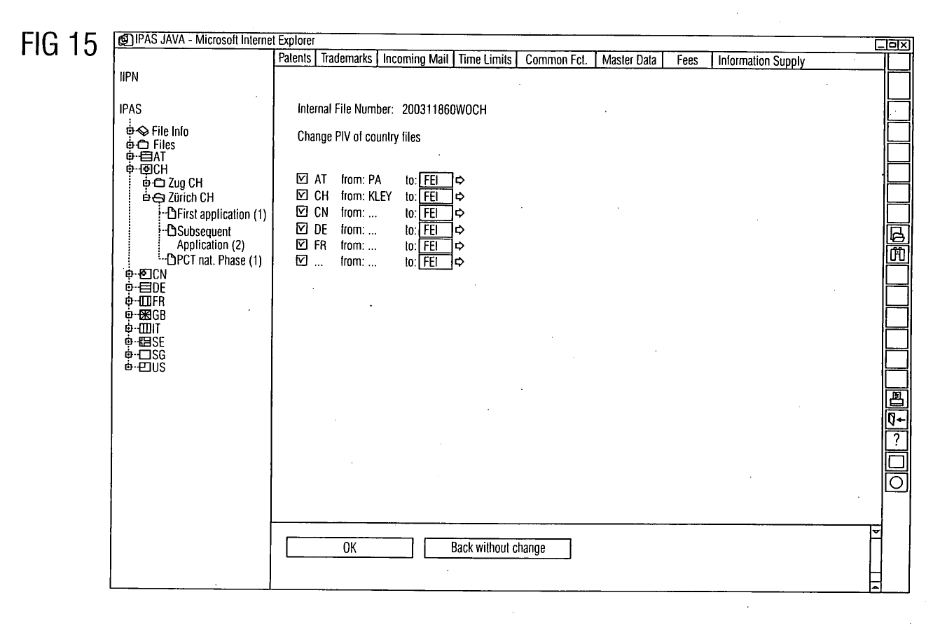

FIG. 15 a screen mask to change the user of a subordinate file,

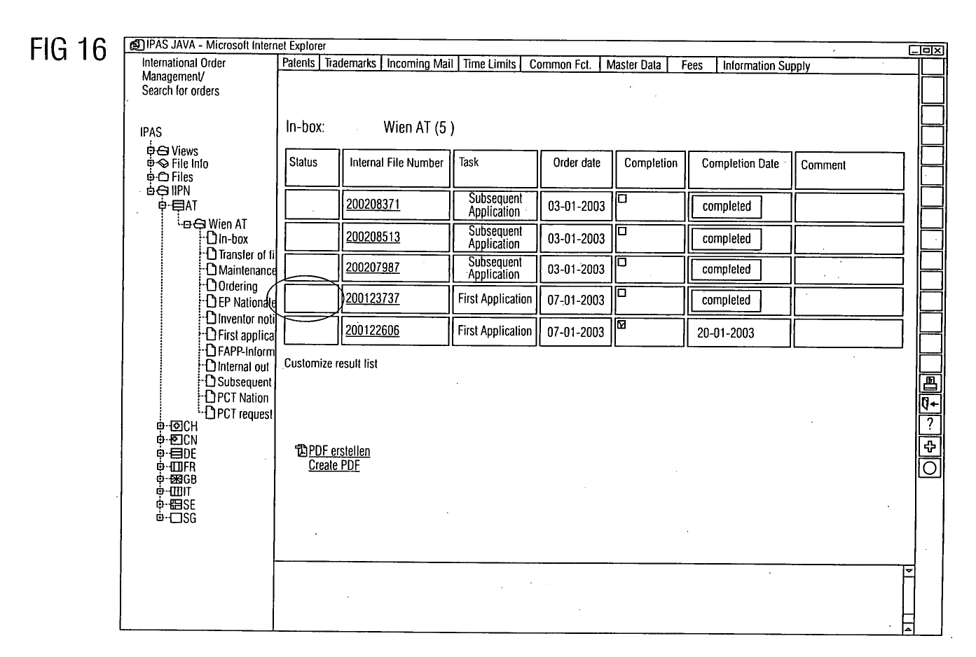

FIG. 16 a screen mask to change a file status

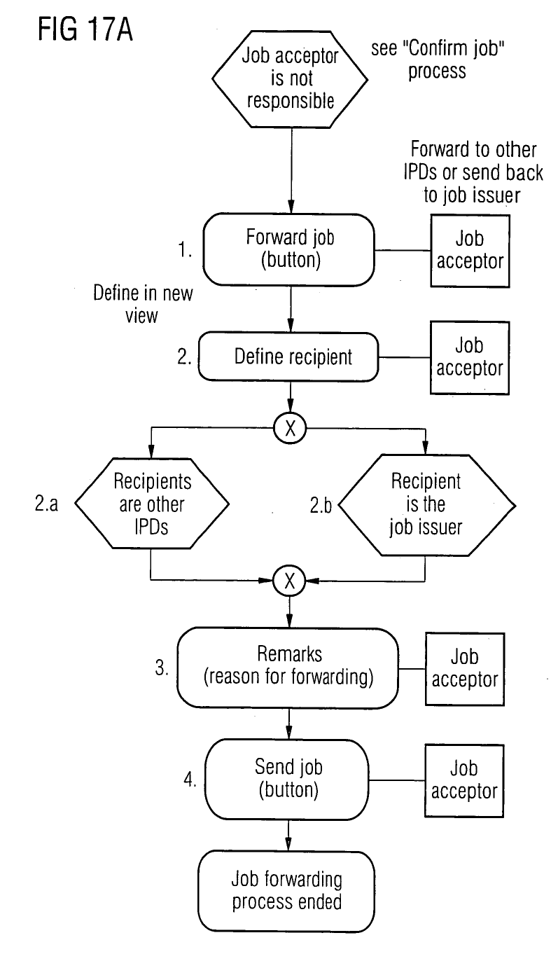

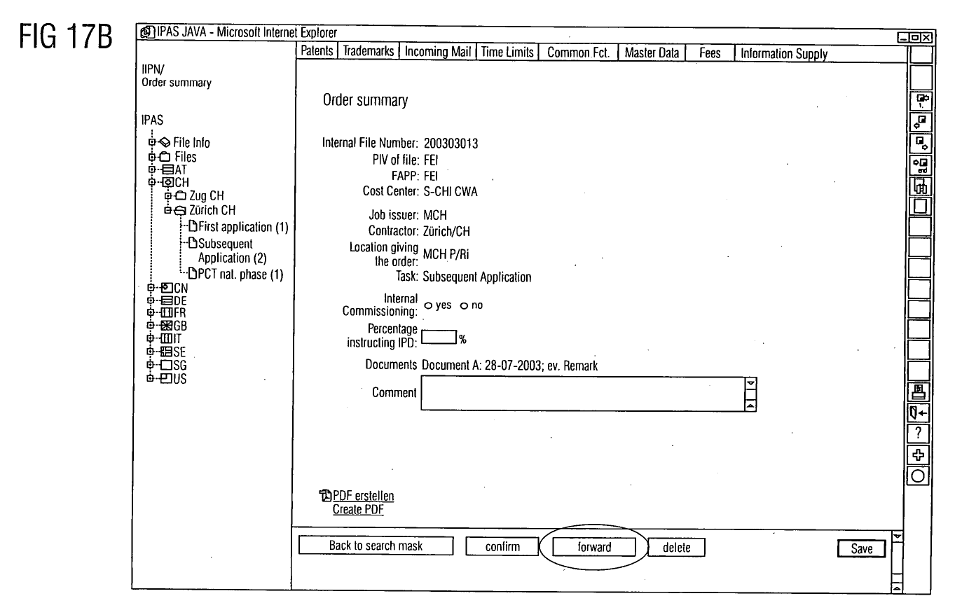

FIG. 17a a flow diagram to forward a job

FIG. 17b a screen mask to forward a job

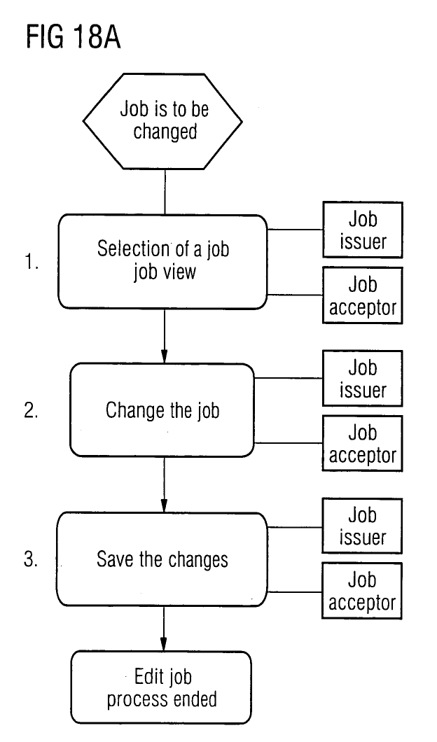

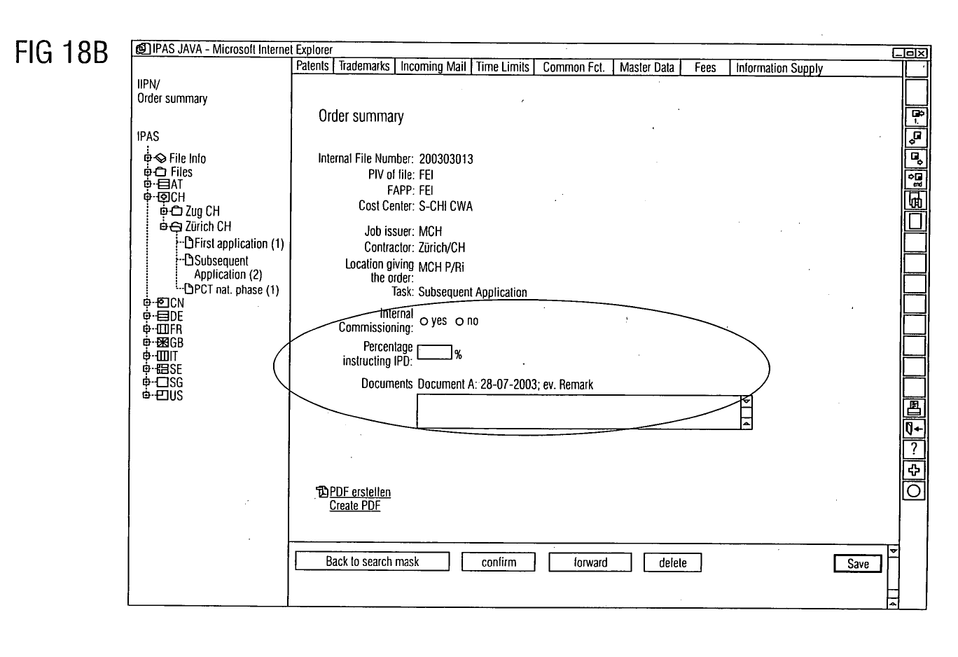

FIG. 18a a flow diagram to edit a job

FIG. 18b a screen mask to edit a job

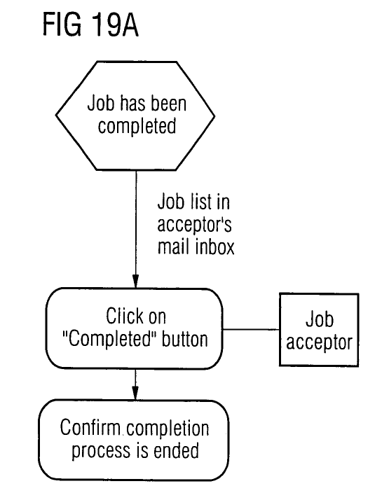

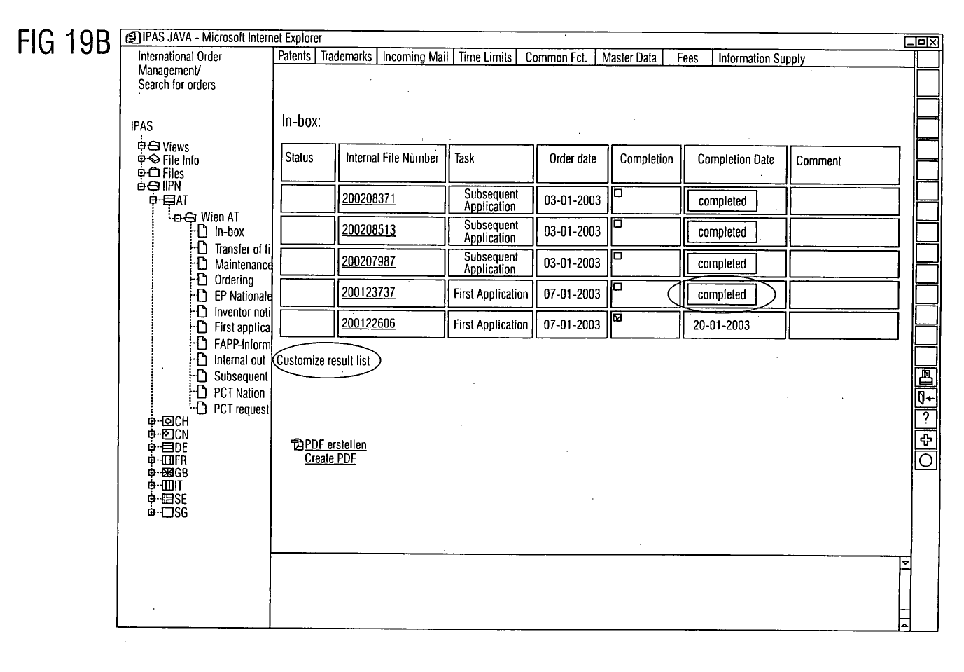

FIG. 19a a flow diagram to confirm a job as completed

FIG. 19b a screen mask to confirm a job as completed

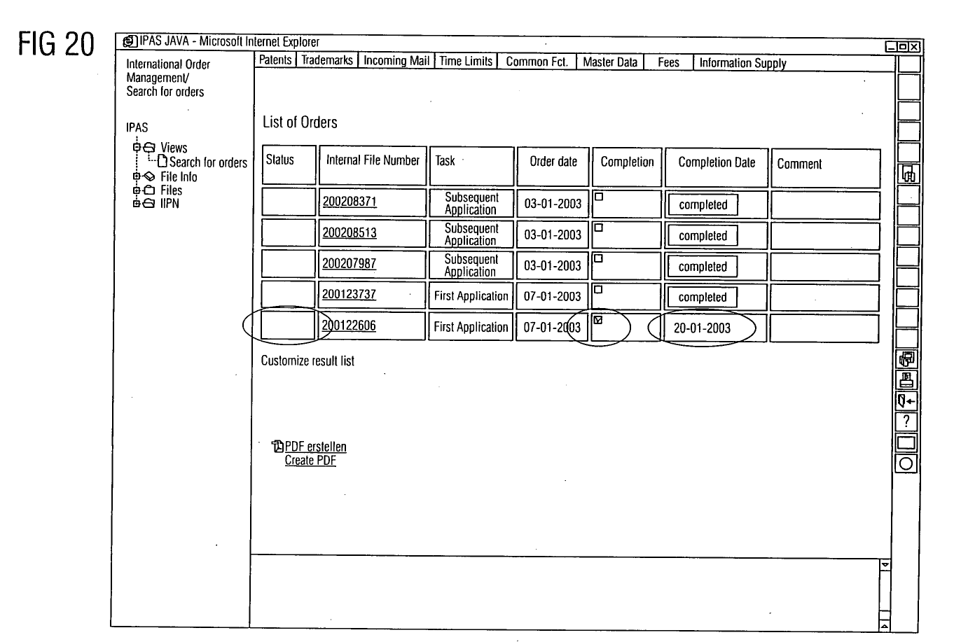

FIG. 20 a screen mask to identify a completed job

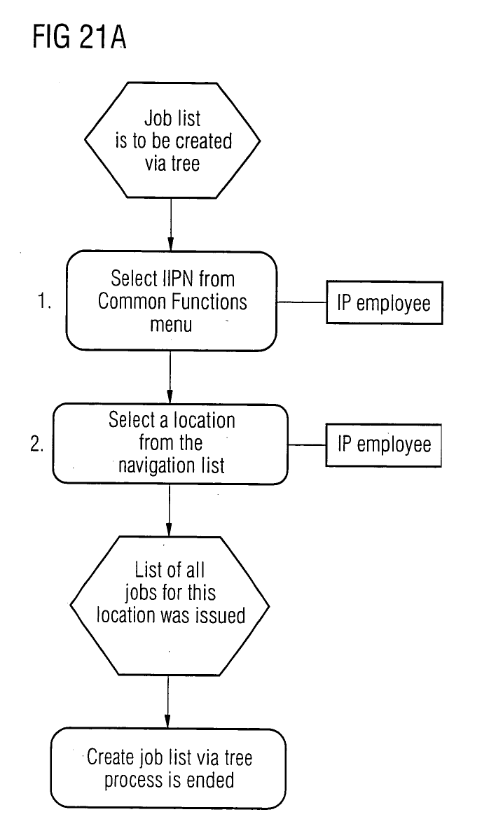

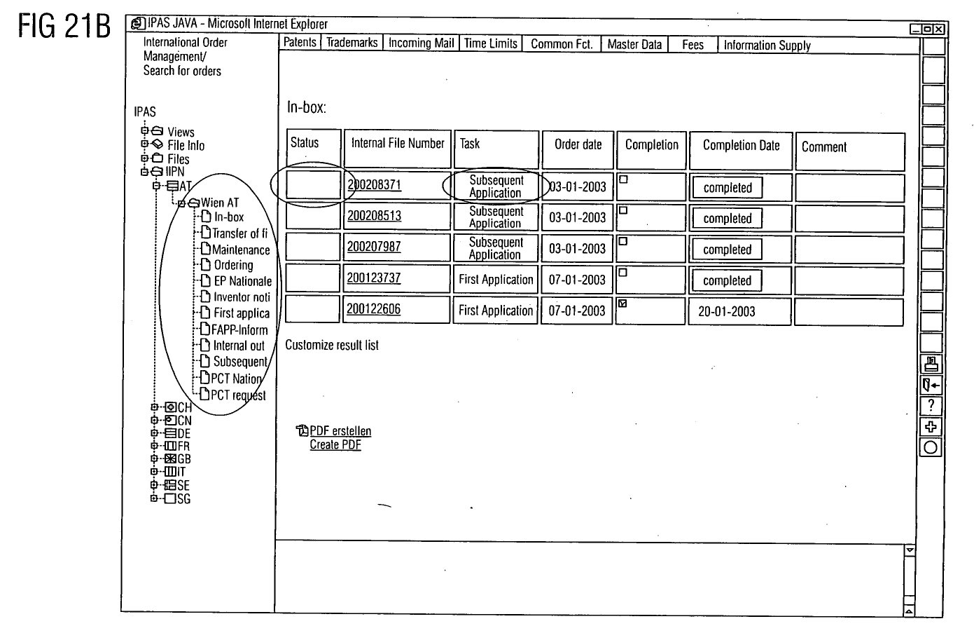

FIG. 21a a flow diagram to create a job list via a tree structure,

FIG. 21b a screen mask for a job list as a tree structure,

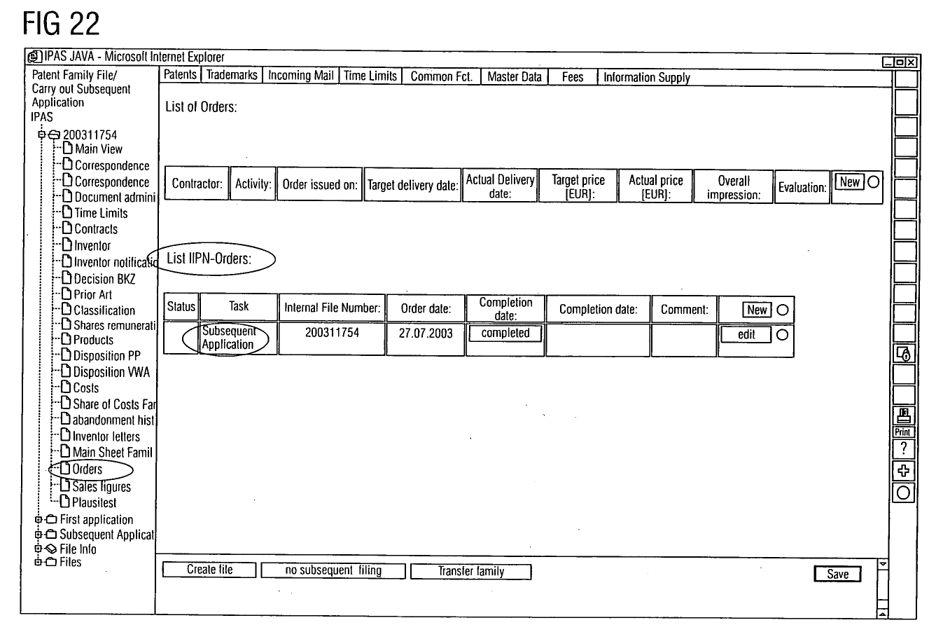

FIG. 22 a screen mask for a file-related job list.

Without restricting the generality, the present invention will be explained using an application environment for a networked job control system of an international patent administration department of a company.

An organizational unit with a job-accepting role is informed about a new job via a function that is comparable with a mail inbox. It is therefore easy to recognize which unit is processing which job and/or the status of any job or file to be processed. Furthermore, the history of job placement can be tracked in a special data view.

Depending on the job, mandatory fields for a data record or relevant document that have to be completed or created by the job issuer, are shown automatically. An organizational unit with a job-issuing role must enter all the required information as otherwise the job cannot be issued. The completeness of the job to be placed is ensured by the job control system checking whether all the mandatory details and documents are available.

Using automatic job control, in which cooperation agreements between individual organizational units of a company are stored in the job control system, it is possible that certain jobs need no longer be placed manually but instead transferred to the job control system that automatically places the relevant jobs with the appropriate organizational units that then process the jobs.

If the job-accepting organizational unit accepts the job, the necessary views for processing are generated or the job accepter can change the user.

The following jobs can be handled by the job control system:
Initiating an application for an invention,
Preparing and filing a patent application,
Drafting an initial application,
Subsequent application,
Handling EPÜ and PCT applications in the national phase,
Accepting and transferring files,
Internal job placement,
Ordering priority documents,
Queries from a cost controller,
PCT vetting application,
Maintaining patent rights.

For selected job-accepting organizational units, individual deadlines can be set in the job control system by the job issuer within which their job must be processed. The deadlines triggered for specific jobs are defined for each job within the job control system in master data tables for deadline control.

A new job can be created using the job control system. This job is automatically or manually sent to the job-accepting organizational unit. The status of the placed job can be tracked using the appropriate colored background in the mail inbox of the relevant job-accepting organizational unit.

Furthermore, in each file for which a job has been issued in the job control system, and where this job has not been confirmed, an appropriate marker is visible.

If the job-accepting organizational unit accepts the job for processing, it must confirm this. As long as the job is not accepted i.e. confirmed by the job accepter, the job accepter can still delete the job.

It is also possible for the job accepter to forward the job to another organizational unit or to return the job to the job issuer due to lack of authority.

Using the job search, jobs can be selected using certain criteria via a search mask and then a job list is generated. A job list can also be generated directly from a tree in a navigation bar. All job lists can be printed. It is also possible to store previous searches and to recall them. All jobs for a certain file are also displayed in a special screen mask. The appropriate hit list can be exported to current office application software such as Excel.

The table below gives an overview of possible applications for the job control system.

| No. | Reference | Description |
|---|---|---|
| a | Search for job | Job searches can be based on different |
| | | criteria (including location of job |
| | | issuer, job accepter, user, file |
| | | reference, cost center). |
| b | Save search | If searches are often made based on the |
| | | same criteria, the search can be saved. |
| c | Recall search | Stored searches can be recalled at any |
| | | time for new searches. |
| d | Display job | Only those jobs are displayed that |
| | | match the search criteria. |
| e | Create job | Via the ‘jobs’ view within a file, a |
| | | job can be created and sent by a job |
| | | issuer for a particular job-accepting |
| | | location. |
| f | Delete job | Once the job has been issued, the job |
| | | issuer can still delete the job that |
| | | has been sent as long as the job |
| | | accepter has not yet accepted i.e. |
| | | confirmed the job. |
| g | Confirm job | If the job accepter accepts the job for |
| | | further processing, he must confirm the |
| | | job acceptance. The yellow marker in |
| | | the ‘traffic light system’ indicates |
| | | that the job is being processed. |
| | | Once the job has been accepted it is |
| | | possible to change the user. |
| h | Forward job | The job accepter can forward the job |
| | | due to lack of personal/departmental |
| | | authority or return it to the job |
| | | issuer. |
| i | Edit job | The job accepter can also change the |
| | | job if necessary. |
| j | Confirm job as | The responsible job accepter reports to |
| | completed | the original job issuer that the job |
| | | processing is complete or the job is |
| | | automatically marked as completed using |
| | | the completion trigger stored in the |
| | | job control system. |
| k | Print job | It is possible to print the job from |
| | | the relevant view. |
| l.a | Create job list | The job list can be generated from a |
| | via search mask | job search based on different criteria |
| | | (including location of job issuer, job |
| | | accepter, user, file reference, cost |
| | | center). |
| l.b | Create job list | The job list can also be generated via |
| | via tree | the tree in the navigation bar, i.e. |
| | | you can select the required jobs from |
| | | all the jobs in a file, sorted by |
| | | location. |
| l.c | Create job list | The job list can be generated via a |
| | via ‘Outfarm | complete overview of all jobs shown in |
| | jobs’ view | the ‘Outfarm jobs’ view of the job |
| | | control system in a file. |
| m | Print job list | The job lists generated via the search |
| | | mask or tree can be printed. |
| n | Show all jobs | A complete overview of all the generated |
| | in a file | jobs within the job control system of a |
| | | file are displayed in the ‘Outfarm |
| | | jobs’ view. |
| o | Open mail inbox | The mail inbox can be opened via the |
| | | tree in the navigation bar. |

For the explanations below, model elements of extended event-controlled process chains are used.

An event describes the occurrence or existence of a status that functions can trigger.

A function describes an effect on or transformation of objects such as information or persons to achieve a particular objective.

Connectors provide logical links as a process splits or merges. A distinction is made between
Conjunction (AND),
Adjunction (OR or AND/OR),
Disjunction (EXCLUSIVELY OR, XOR).

Edges describe links between model elements to describe a control flow.

A processes interface provides a reference to continuing the business process model in another business process model.

An organizational unit provides a link to functions, such as the authority to execute a function.

Some of the terms used frequently in the subsequent descriptions are described in more detail below.

Traffic Light System

A traffic light system in the mail inbox of a location informs both the job issuer and the job accepter about the status of an issued job. If the job-accepting location has received the job and not confirmed it yet, the job is shown against a red background, after the job confirmation, i.e. during the processing of the job by the assigned location, the job appears against a yellow background. If the job is completed and the report is delivered to the job issuer, the job is shown against green.

Job

A job issuer issues a job to a job accepter, i.e. an order which is to be completed by this job-accepting location. This job is the pre-requisite that one or more new jobs will be started which may create further jobs or trigger further processes. A job is identified by the order, the job issuer and the job accepters, dates referring to the beginning and end of the job processing process or processing deadlines.

Automatic Job

An automatic job is created by triggering certain triggers (see below). Depending on the triggered trigger a job from an integrated patent application software system (IPAS) is automatically created as part of the job control system (IIPN—international intellectual property network) and forwarded to a particular, job-accepting location which, based on pre-defined authorities/characteristics and the existence of a cooperation agreement, is then responsible for processing the job.

Job Issuer

The job issuer sets authorities, deadlines etc for the job issued by him and its processing and makes the necessary documentation available. Job issuer includes all the employees at the job-issuing location.

For the subsequent application and PCT process, the job issuer must work in the appropriate family.

New Jobs

If a job is created and sent to a job-accepting location, this job appears in the mail inbox of the job accepter. Until the job accepter accepts this job, it has a red background. The new job is visible to the job accepter.

Job Accepter

The job accepter is a location or a department with whom there is a cooperation agreement. Based on predefined triggers a job issue is automatically generated. The trigger determines which location is issued with the job.

A job accepter includes all the employees of the relevant location/department and only these employees are authorized to issue confirmation regarding job acceptance or similar.

For the subsequent application and PCT process, the job accepter must work in the appropriate file.

Automatic Job Issue and Control

Based on a predefined trigger and the existence of a cooperation agreement, a job issue and control is automatically generated. Triggers can be buttons, templates or particular file types. Jobs are automatically issued in international job management based on a pre-defined table.

Manual Job Issue

If there is no trigger to issue a job automatically, the jobs are issued manually, i.e. the job issuer must complete the ‘Create job’ process and send it to a job-accepting location.

History of Job Issue

The history of the jobs processed via the International Job Management is displayed in an appropriate view in the file and in the family. Each forwarding, confirmation, change or deletion is recorded.

Internal Service Charges

The internal billing costs that result from the job are transferred to a particular cost code (percentage share) for various organizational units (IPD—intellectual property department).

The share of the job is stored in the job. The share is entered by the job-issuing location. Any authorized IIPN user may change the percentage share. The share is only possible until the job is completed.

Mail Inbox

The mail inbox of the job accepter contains all the jobs issued by the job issuer that have to be confirmed. The overview of these jobs is provided in a table where the status of the file (see traffic light system), the job, the file reference (acts as a link to the job view), the job and completion date (including ‘completed’ button) can be seen.

Cooperation Agreements

The cooperation agreements regulate the responsibilities between the job-issuing and job-accepting locations. A job can only be automatically issued if there is a cooperation agreement.

There is an option to restrict the duration of the cooperation agreement by entering a date in the appropriate master data mask. The cooperation agreement can be restricted to certain processes or countries.

Description of Actual Applications

Search for Job

Job searches can be based on the following criteria:
Job accepting location (IPD)
Job issuing location
User department (PIV) for the file or the user when the job was issued
PIV of the file or PIV job (=PIV at the time the job was issued)
Internal file reference
Cost controller (FAPP)
FAPP department
FAPP location
Cost center (BKZ)
Job date
Job confirmed yes/no
Job
Job completed yes/no
International service charges: Box to check (if yes)

The job list which is generated via the search mask is a freely designable event list where the columns can be selected by the user. If required all the search fields can be displayed in the results list. The standard display though is that shown in the screenshot (FIG. 1b). The job list which is displayed in the ‘jobs’ view in the file is not freely designable.

If you want to search for an IIPN job, first select ‘IIPN’ from the ‘Common functions’ menu (FIG. 1a). In the search mask, you can select the required search criteria and enter the necessary data. Clicking on the ‘Search’ (binoculars) or Enter key) in the right-hand button bar completes the job search: see ‘display job’ process. Results list (mail inbox) can also be called up via the tree.

Save Search

You must have already run the ‘Search for job’ process. All the searches selected in the ‘Search for job’ process can be saved for future use by clicking on the ‘Save search’ (disk symbol) button in the right-hand button bar.

Display Job

The results list for the IIPN jobs must be open. A job is selected from a job that appears there. Previous processes are: ‘Search for job’ or ‘Create job list’ Once the ‘Search for job’ or ‘Create job list’ has been completed, a table overview is displayed with all the jobs that match the search criteria (see FIG. 2). These jobs can be sorted by status. From this overview, individual jobs can be selected for closer inspection (display) (file reference=link to the appropriate job) or a printable pdf file can be generated from the list.

The job list is a ‘freely designable results list’ which means that a results column can be displayed for each required search criteria (selection of columns, see FIG. 3).

If the job list is generated from the tree, the ‘completed’ column is not displayed (defined, gray background). Once the selected job has been displayed, it is possible confirm, delete, forward or edit the job.

The job list generated via the search function is a ‘freely designable results list’ which means that a results column can be displayed for each search criteria (FIG. 3). The columns can be selected in mask shown above ‘Free list IIPN jobs)’. In the selected job view (printable as pdf document) as per FIG. 4 there is a ‘Back to results list’ icon.

Create Job

The job issuer creates a new job for a particular file in the IIPN (under ‘Common functions’), or via the ‘Jobs’ view in the family file (internal jobs). The job is in a country file, but the ‘jobs’ view is only visible in the family. When all mandatory fields have been completed and when all documents for this job have been created (i.e. available in either the view document management family or country file) the job can be transmitted to the job-accepting location. If there is a cooperation agreement for the relevant aspect with the particular location, the job accepter is automatically suggested, if not the job accepter is assigned manually.

The job cannot be sent until all mandatory fields have been completed and the documents are available. Those fields/documents which are mandatory fields/documents, are coded using master data tables and plausibilities (file and family). The job can only be sent when all the mandatory information has been completed. (Click on ‘Send’ button).

In the tree in the navigation bar all the jobs are listed arranged by location and order. This tree can be viewed in any view in IPAS. The processing status and location of the file is visible in the mail inbox for every location. If at the location in the mail inbox a job has a red background, it means that this location has been assigned a new job but has not yet confirmed its acceptance. A yellow background to the job means that the job has been accepted for processing and has therefore been confirmed. A green background means that this job has been processed by the relevant location and is confirmed as completed.

Furthermore, in addition to the location reference in the tree of the navigation bar, the number of jobs which are not confirmed where appropriate by order (bold number in brackets) is displayed to provide a better overview of the number of open jobs.

The trigger event is that the file has to be further processed by other IPDs. Therefore, it is necessary to create a new job for this job accepter (‘New’ button).

Below is an example of an initial application. A location in Germany is currently overloaded with work and would therefore like to transfer the initial application to a location in Great Britain.

There is an administrator (VWA) assigned to the FAPP, the family and the file for the initial application and generated in the IIPN a job for the location in Great Britain in which you defined the job accepter, complete the mandatory fields specific to the job (here for example the ‘delivery date’ field (i.e. by when the GB location has to complete the job) and send the job. When the job is sent, an automatic return deadline is set by which time the job accepter must confirm the job.

The British VWA sees a new job for initial application in his mail inbox which is not yet confirmed (marked red) and then accepts the job or forwards it to another location.

The process can be divided as follows:
In the ‘International Job Management’ menu under ‘Common functions’, you can access the IPAS search mask for the International Job Management (IIPN)
Via the ‘Jobs’ view in a family file, you can create an IIPN job (internal job) by clicking on ‘New’. After clicking on ‘New’, the view 1/3 of the IIPN job creation appears (FIG. 7). Here the internal file reference is pre-completed with the family file reference.
By clicking on ‘New’ the recording for the new job is started. Depending on the job, various mandatory fields have to be completed or documents created. The following data is especially important:
   Authorities and order (View 1 of 3)
   Job issuer (default current user; can be changed via white input field with blue arrow)
   Job accepter: using the blue arrow only locations (IPDS) can be selected
   int. AKZ (can be changed via data field or blue arrow):
the internal file reference can be the family file reference but is usually a country file reference
   Order—can b issued via the dropdown field
So that the data for a file is available (PIV, BKZ etc.), the file for a given file reference is loaded via the ‘Load file information’ button.
Using the ‘back’ and ‘next’ button, the user can toggle between the individual views (one view back or forwards) to complete the details.
Using the ‘cancel’ button, the job creator is taken from views 1/3 to 3/3 back to the search mask (without making any changes).
Complete mandatory fields and optional fields (View 2 of 3) (FIG. 8)
The data from view 1/3 is pre-completed along with the PIV for the file, the FAPP and the BKZ. The following has to be added
   Date of the job issue (default current date)
   Comment(s) on the job (white input field)
   (Additional) mandatory fields (depending on the job); they are marked with an asterisk
   Internal service charges (checkbox yes/no, or completed with percentage share of the job accepter): ‘Optional field
Create documents (view 3 of 3): Mandatory documents for the relevant job are marked with an asterisk.
The job can only be sent when the mandatory data and documents are completed (plausibilities). The completeness is checked by IPAS (are all mandatory fields completed all documents stored), the job issuer can check again whether the job accepter has the authority to process the job. If the job is complete, the ‘Send’ button can be clicked and the job is transferred. The mail inbox view of the job-issuing location then appears so that a new job can be issued immediately. Item 2 of the graphic refers to the search mask, not to the mail inbox, which appears when ‘send’ is clicked (there is no ‘new’ button in the PEK). If you want to create a new job straight away, there is a ‘Send and create new job’ button.

By clicking on the ‘Send and create new job’ button, the previous job can be sent and new job can be created immediately (clicking on the button takes you directly to view 1/3 of the ‘Create job’ process).

By clicking on the ‘Send’ or ‘Send and create new job’ button a return deadline is automatically sent by which time the job acceptance must be confirmed. If this does not occur, the job accepter decides on the further course of action.

Mandatory fields and documents are distinguished from optional fields and documents by an asterisk after the reference and are stored in the appropriate master data table in the IPAS.

There are also the following additional options:
A new job can be created irrespective of whether the—previous job has been confirmed or not: Click on ‘New’ button
The job has not been confirmed by the job accepter: the job that has just been sent can still be deleted: Click on ‘Delete’ (see process ‘Delete job’). A job can only be deleted by users at the job-issuing location, i.e. the ‘Job delete’ button has the appropriate plausibility. The ‘Delete job’ process explains that only the job issuer can delete the job.
Once the job has been issued, the job accepter confirms the job: The status of the job and the date field for the job confirmation are automatically updated by the system if the job has been confirmed (see ‘Job confirmation’ process’).

As soon as the job has been created and sent, then in the corresponding file in the main view in the title the following appears ‘IIPN to location XYZ’ where location XYZ is the job-accepting location (see FIG. 5-10). This message appears until the job is confirmed.

Create job via ‘Jobs’ view of a family file.

After clicking on ‘New’, the user at the job-issuing location is taken to view 1/3 of the IIPN to create a job (FIG. 5).

Job creation: Click on ‘New’ button in ‘Common functions’ menu, International IP Networking (IIPN) (FIG. 6). If you go via the family (via jobs view), then the internal file reference is pre-completed with the family file reference.

The mask shown in FIG. 9 can be extended to include the option of adding existing documents from the file etc into this document table. The ‘new’ button is added to the right of the document table. This feature is not implemented in the first stage.

If there is an unconfirmed IIPN job for a file, a red heading ‘Int. IPN for XYZ’ appears in the file concerned (main view) (FIG. 10).

Delete Job

This is for deleting a job that has not yet been confirmed by the job-accepting location. He can select the file concerned from the job list of the mail inbox of the job-accepting location by clicking on the file reference.

Previous processes are ‘Create job list (via tree)’ and ‘Display job’.

If a job that has already been sent has to be deleted, the job issuer can click on the ‘Delete’ button provided that this job has not already been confirmed (accepted) by the job accepter (FIGS. 11a and b). The ‘Delete’ button can be found in each job view which has been previously selected from the mail inbox of the job-accepting location.

As soon as the job has been deleted, the link to this job is automatically removed from the mail inbox of the job accepter. The fact that the job has been deleted, cannot be seen by the user.

The trigger is that the job issuer wants to delete a job that has already been sent (e.g. authority of the selected job accepter was not give, job created for wrong file, job no longer relevant etc).

The job is to be deleted: go to the mail inbox of the job-accepting location (see ‘Create job list via tree’) From the job list of the job accepter the job issuer selects a particular job that has not been confirmed (red background) and looks at a view of this job.

This view has a ‘Delete’ button. As soon as this is clicked on, the job is completely deleted from the mail inbox of the job accepter and can no longer be seen by the user.

The selected job has not yet been confirmed so the job can still be deleted (Job still has a red background in the job list in the mail inbox): Click on the ‘Delete’ button. If the job accepter has already confirmed the job (job has a yellow background in the mail inbox list), then the job can no longer be deleted. The documents in the document table that is displayed in the job overview can be clicked on (without buttons) and can thus be opened and printed.

Confirm Job

Previous processes must be ‘Create job list (via tree)’ and ‘Display job’.

The job accepter finds jobs in this mail inbox that he has been assigned and must confirm to the job issuer within the return deadline whether he will accept the job or not. A selected job is confirmed by clicking on the ‘Confirm’ button. The color of the background in the mail inbox of the job-accepting location changes from red to yellow and the return deadline is met.

An IIPN job can only be confirmed by an IPAS user that is part of the job-accepting location (plausibility). When the job is confirmed, the day's date and the user making the confirmation are saved. This can be viewed in the IIPN history (in the family).

After clicking on the ‘Confirm’ button, depending on the file type (NAT or WO/EP/WE file) a mask appears in which the PIV of the file can be changed via a white input filed and a blue arrow. The PIV is preset with the previously assigned PIV and the corresponding location. For the NAT file type, after making changes or without any change, the ‘Action complete’ button takes you back to the mail inbox of the job-accepting location. For the WO, EP or WE (umbrella file) file types, in the ‘Change PIV’ view there is a further button labeled ‘Change PIV of country file’.

After clicking on this button, another view appears in which the PIVs of the individual country files can be changed (via white input field with blue arrow). Those country files for which the PIVs should be changed are selected via the adjacent checkbox. (By default, all the checkboxes for the country files are checked which means that for all country files where nothing has to be changed, the checkbox has to be deactivated so that it is empty). The current PIV of the country file and its location are pre-completed; in the default setting, the PIV of the corresponding umbrella file (that may have been changed previously) is entered in the white input fields. Once the selected country file of the PIV has been changed, clicking on the ‘Action complete’ takes you back to the mail inbox of the job-accepting location.

If the job for various reasons (lack of authority, lack of time etc.) is not processed by the assigned location, then there is an option to forward the job or return it to the job issuer.

Each forwarding, confirmation, change or deletion is recorded automatically in the IIPN history (view in the family).

The trigger event is the receipt of a new job: Message in mail inbox of the job accepter.

Via the ‘Create job list (via tree)’ process, the job accepter is taken to the mail inbox for his location (FIG. 12a). This mail inbox shows whether new jobs have arrived. From the list the job accepter selects a job that has not yet been confirmed. Once the selection is made, the job accepter sees a view of the job using which he can check the application (whether the job-accepting location has the authority). Depending on the result, the job-accepting location decides on the next course of action (‘Job confirm’ or ‘Job forward’ button). The job can also be changed. If the order is confirmed, then in the next view the PIV for the relevant file is selected. If this is an umbrella file, then this view also has a button labeled ‘Change PIV of country file’ which when activated takes you to another view. For NAT files this button does not appear however. For umbrella files, the PIVs of the individual country files can be changed individually in this view. The checkbox for each country file that needs changing has to be marked. The PIV of the umbrella file is automatically suggested as the new PIV but this can be edited in the white input field with a blue arrow.

The job accepter accepts the job for further processing: Click on the ‘Edit job’ button. The ‘traffic light system’ for the status automatically changes to yellow (job in the mail inbox of the location now has a yellow background) and the deadline for the job is triggered. The job accepter forwards the job to another location with authority: Click on the ‘Forward’ button. Job accepter returns the job to the job issuer: Click on the ‘Forward’ button. The job accepter can also change the job. The job is confirmed by clicking on the ‘Confirm’ button in the job view (FIG. 12b.)

There is also an option to change the PIVs of the individual country files by clicking on the ‘Change PIV of country file’ button (FIG. 13-15). If this is not required, clicking on the ‘Action complete’ or ‘Back without making changes’ button takes you to the mail inbox in the job-accepting location.

In the “Change PIV of the country file” view, only the child files of the relevant umbrella file are shown. Each country file where the PIV has to be changed is selected via checkbox and edited using the white input field or the blue arrow. Clicking on ‘Action complete’ confirms the action takes you back, the same as clicking on ‘Back without making changes’, to the mail inbox of the job accepter (location). The status change based on the confirmation of the job is visible in the mail inbox of the job accepter (FIG. 16).

Forward Job

T Previous processes are ‘Display job’ and ‘Confirm job’.

Once the job accepter has checked whether his location has the authority for the received job (view) and noted that this authority is missing, the job should be forwarded to another location for processing. The job accepter then clicks on the ‘Forward job’ button, in the next view, enters the data on the next recipient (=a location), comments on the job and/or forwarding and sends off the job. In this case, the return deadline set by the previous job issuer is met and a new return deadline is triggered for the new job accepter. The job issuer remains the original job issuer (=the location that created the job). The forward is displayed in the IIPN history of the file (view in the family).

The job accepter can decide based on the entry in the recipient field whether the job should be forwarded to another competent person/department or whether the job should be returned to the job issuer.

The trigger event is the result of the checking process for the job (see ‘Confirm job’ process) which states that the new job cannot be processed by the job recipient (no authority or lack of time . . . ).

If the job has to be sent to another authority or returned, you have to click on ‘Forward’ (FIGS. 17a und b). The recipient is entered in the next view. The ‘Comment’ field (such as reason for forwarding or additional information relating to processing) is then completed. By clicking on the ‘Send’ button, the job now appears with a red background in the location overview of the selected recipient. When this new recipient selects the job, he receives a view of the job and can now accept the job for further processing (‘Confirm job’) or forward it (‘Forward job’) or change it (‘Edit job’).

If the job-accepting location is not competent to process the job but another location is competent and authorized, the complete job is forward to that location If after checking the job there is a reason to return the job, then the recipient is the original job issuer (creator of the new job).

Edit Job

Previous processes are ‘Create job list (via tree)’ ‘Search for job’ and ‘Display job’.

If the job accepter has received a job (mail inbox), he can select a particular job (file reference=link to job) and then receives a view of the job. The ‘Internal Service Charges’, ‘Job accepter share’ and ‘Comments’ fields can be changed. Clicking on ‘Save’ stores the changes for the job.

The job accepter now has the choice of forwarding the changed job, confirming it or making further changes.

The job can be edited as many times as required. Clicking on ‘Save’ shows the job overview again with the amended data. This job view can be printed by clicking on the pdf symbol. Amended data must be confirmed by clicking on save, or the changes will not be visible in the printout.

The trigger event is that the job accepter or job issuer wants to make changes to a job.

Once a job has been selected from a job list and is available to view, the job can be changed (FIG. 18a). Changes to the available fields. The data is saved by clicking on ‘Save’. A job overview appears again showing the changed data which can be changed again. The job can be edited, forwarded or confirmed.

Clicking on ‘Back without making changes’ takes you to the search mask (FIG. 18b). Clicking on ‘Save’ saves any changes and the job overview appears again with the changed data. If you want to return to the mail inbox, you can click on the required location in the navigable tree.

Depending on the status of the job, a number of buttons: until the status is yellow, the buttons ‘delete’ forward’ and ‘confirm’ are visible, from then on the job can only be edited or printed (pdf symbol).

Confirm Job as Completed

The job-accepting location must have accepted the job and selected a PIV. The job accepter then completes the issued job, such as an initial application, i.e. he creates an initial application for a particular file.

The job-accepting location has accepted a job of the IIPN for processing and depending on the job for example creates an initial application in the IPAS. If this job is completed or not is determined by an automatic mechanism. The job is only seen as completed when the job-completion trigger (see below) is triggered. When the job is completed (trigger is triggered) the color of status of the file in the mail inbox (job list) changes from yellow to green and/or the date of the completion may be automatically entered.

The job issuer knows from the job list of this location that this job has been completed because the status can be clearly seen from the green background.

In the results list of the search (via search mask or ‘Jobs’ view) a tick is also visible in the ‘Completed’ column (unchangeable). This column is not visible in the search via the tree.

The job-completion trigger is a job-specific code that is stored in the IPAS database for the required job type. In principle, the job-completion triggers functions as a deadline trigger, i.e. it is triggered if certain pre-defined conditions are met. For IIPN jobs, the job-completion trigger is triggered as soon as all the data for the relevant job is entered (all plausibilities are met) and the event stored in the master data is triggered. By triggering the trigger, the following actions are started:
Completion date (day's date) automatically saved: Visible in the mail inbox of the job-accepting location or in the history (here with additional data as to which location has completed the job)
Status change of the job in the mail inbox of the job-accepting location (from yellow to green)
For the file concerned, a tick is automatically entered in the ‘Completed’ column in the job list, which is generated via the search mask or the ‘Jobs’ view, to show the job has been completed.

As soon as a job has been processed, the responsible location must confirm the completion. The ‘Completed’ button in the job list in the mail inbox must be clicked on. After clicking on the button, the status of the file changes from yellow to green.

The job issuer knows from the job list of this location that this job has been completed because the status can also be clearly seen from the green background.

The assigned job has been completed by the job-accepting location (plausibilities are met: pre-requisite for automatic confirmation of completion).

In the mail-inbox of the job accepter the job list is displayed (FIG. 19a). If you want to report the completion of a particular job, it is not necessary to open the job, instead it is sufficient to click on the ‘Compete’ button in the job list. In the column on the right, the date of the report of the completion is automatically entered and/or the status color of the file changes from yellow to green.

You can confirm the completion of a job manually by clicking on the ‘Complete’ button in the mail inbox of the job-accepting location (FIG. 19b). If this button is clicked, the date of the completion appears in its place and the status color of the job changes from yellow to green (FIG. 20).

Print Job

A specific job must be selected on the results list of the search or mail inbox. Clicking on the file reference (=link) displays the job view.

Jobs in the International IP Networking can be printed at any time. Clicking on the ‘Create PDF’ symbol in the job view generates a pdf document.

Create Job List (Via Tree)

If you to see a particular location in the job list, you can use the tree in the navigation bar instead of the search mask (FIG. 21b). Clicking on the folder of the required location opens the view with all the assigned jobs for this location, sorted by job status (jobs that have not been confirmed appear first). This view of the job list matches the mail inbox of the location. In the selected location, it is also possible to view the mail inbox for particular jobs (e.g. all jobs for initial applications).

First select the required location in the IIPN (submenu of ‘Common functions’) from the tree in the navigation bar (FIG. 21a). As soon as the location folder is clicked on, a view appears that displays the mail inbox of this location (or a particular job in this location). The jobs listed can be selected by clicking on the file reference (=link) and viewed (job overview).

Overview of all jobs received at a location: By selecting a particular job (navigation bar), it is possible to filter the mail inbox of the location by job.

The mail inbox shows unconfirmed jobs, jobs being processed and completed jobs that are not older than xx months. The length of time a completed job is displayed in the mail inbox is defined in the ‘Job’ master data table.

In the file associated with the job, all the assigned jobs are visible in the ‘jobs’ view.

Print Job List

Previous processes ‘Create job list (via search mask)’ or ‘Create job list (via tree)’. Each job list can be displayed as a pdf document and then printed (‘Create PDF’ symbol).

Show All Jobs in a File

To obtain an overview of all the assigned jobs of the IIPN of a particular file, open the ‘Jobs’ view of the family or invention application (FIG. 22). The job list visible under ‘List of International IP Networking’ contains for each IIPN job issued for this file irrespective of the job issuer, job accepter, status, order etc.

The above descriptions of the method are provided only by way of example to facilitate understanding. The application of the present invention is not restricted to the examples described.

1. Method for controlling job processing, in which
in response to a job-processing request from a first unit based on control parameters for job processing by at least a second unit, job information is created for a job to be processed by the second unit.
the job information is stored in a job memory for retrieval by the second unit.
the job information includes at least a job descriptor, an event and status indicator, a predefined completion time and details about the resources assigned for the job to be processed.
changes to the event and/or status indicator are continually logged.

2. Method according to claim 1 in which the job information stored in a job memory is also available for retrieval by the second unit.

3. Method according to claim 1 [[or 2]], in which the job information stored in a job memory is arranged according to organizational units and/or locations assigned to the first and/or second unit.

4. Method according to claim 1 in which the details about the resources assigned for the job to be processed indicate an operator or file location.

5. Method according to claim 1 in which the control parameters are stored in a parameter file for cooperation agreements.

6. Method according to claim 1 in which the logged changes to the event and/or status indicator for the first and/or second unit can be retrieved.

7. Method according to claim 6 in which the logged changes to the event and/or status indicator are provided in the job memory.

8. Job control system with
a device for generating job information, in response to a job-processing request from a first unit based on control parameters for job processing by a second unit, to be processed by the second unit,
a device for making the job information available for retrieval in a job memory for the second unit,
the job information includes at least a job descriptor, an event and status indicator, a predefined completion time and details about the resources assigned for the job to be processed.
a unit for continually logging changes to the event and/or status indicator.

9. Method according to claim 2, in which the job information stored in a job memory is arranged according to organizational units and/or locations assigned to the first and/or second unit.
